(19) United States
(12) Patent Application Publication
(10) Pub. No.: US 2009/0322717 A1
(43) Pub. Date: Dec. 31, 2009

(54) FIELD EMISSION DISPLAY DRIVING CIRCUIT

(75) Inventor: Yangkai Lin, Taipei County (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/182,549

(22) Filed: Jul. 30, 2008

(30) Foreign Application Priority Data
Jun. 25, 2008 (TW) 097123677

(51) Int. Cl. G09G 5/00

(52) U.S. Cl. 345/205

(57) ABSTRACT

A field emission display (FED) driving circuit is disclosed. The FED driving circuit is used for controlling a FED and monitoring the operation of the FED driving circuit. The FED driving circuit can simulate an image according to the image data by using a field programmable logic gate array and a computer simulating terminal, and output the result of the simulation to the MCU to complete a feedback calibration.

### BACKGROUND OF THE INVENTION

This Application claims priority of Taiwan Patent Application No. 097123677, filed on Jun. 25, 2008, the entirety of which is incorporated by reference herein.

1. Field of the Invention

The invention relates to a field emission display driving circuit, and more particularly to a field emission display driving circuit for feedback calibration.

2. Description of the Related Art

Conventionally, when a driving circuit is used for driving a field emission display (FED), a TV generator is provided for generating an image signal and outputting the image signal to a FED panel through a controller. The panel generates a display according the image signal.

Please refer to FIG. 1. FIG. 1 shows a block diagram of a conventional FED driving circuit. The FED driving circuit 1 comprises a TV generator 11, a controller 12 and a FED panel 13. The TV generator 11 generates an image signal for transmission to the controller 12. The controller 12 controls the image signal for output. With the control of the image signal from the controller 12, an expected image for designers is displayed on the FED panel according to the image signal.

However, under such conditions, when there are defects in control chips of the controller 12, an unexpected display on a FED panel will occur. Moreover, locating the source of the unexpected display, for example, whether the unexpected display is induced by the panel or the controller, is not easily available. Thus, a need exists in the art to overcome the aforementioned problems.

### BRIEF SUMMARY OF THE INVENTION

Therefore, one objective of the invention provides a field emission display driving circuit for controlling a field emission display and monitoring the operation of the field emission display driving circuit. The field emission display driving circuit comprises: an image generator for generating an image signal; a micro controlling unit coupled to the image generator for receiving and controlling the image signal for output; a controlling device coupled to the micro controlling unit for receiving the image signal and outputting image information; a display unit coupled the controlling device for receiving the image information and displaying an image according the image information; a field programmable logic gate array coupled to the controlling device for receiving and performing an operation on the image information for output; and a computer simulating terminal coupled to the field programmable logic gate array and the micro controlling unit for receiving the processed image information, simulating a display according the image information, and outputting the simulation result to the micro controlling unit for feedback calibration.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a block diagram of a field emission display (FED) driving circuit according to the prior art; and

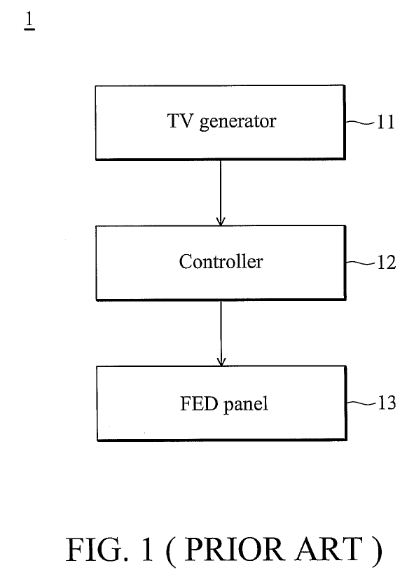

FIG. 2 shows a block diagram of a field emission display driving circuit according to a preferred embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

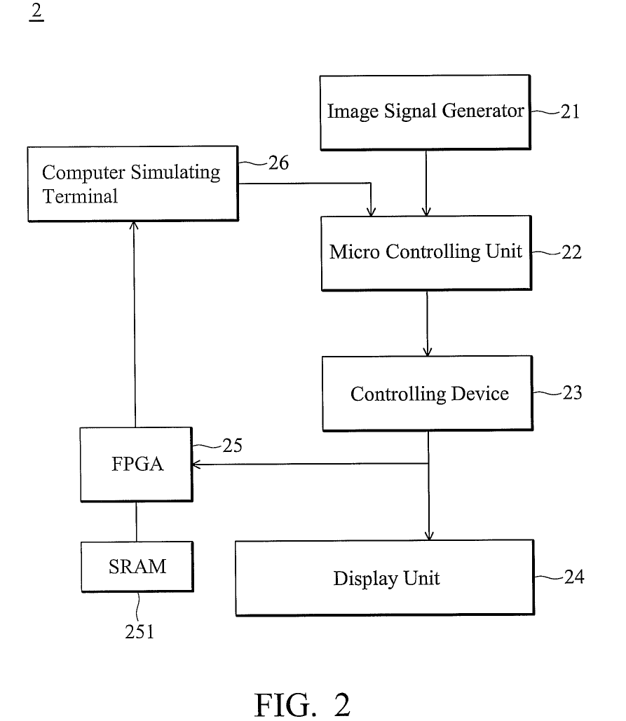

Please refer to FIG. 2. FIG. 2 shows a block diagram of a field emission display driving circuit according to a preferred embodiment of the invention. As shown in FIG. 2, the field emission display driving circuit 2 comprises an image signal generator 21, a micro controlling unit 22, a controlling device 23, a display unit 24, a field programmable logic gate array (FPGA) 25, and a computer simulating terminal 26.

First, the image signal generator 21 generates an image signal having data for displaying an image such that the display unit 24 displays the image according the image signal. The micro controlling unit 22 coupled to the image signal generator 21 is used for receiving the image signal from the image signal generator 21 and controlling output of the image signal according to a control signal inputted externally.

In addition, the image signal may comprise multiple display signals, such as image signals for displaying time and channels. The micro controlling unit 22 may control and output different image signals according to the control signal. The controlling device 23, coupled to the micro controlling unit 22, is provided for receiving and controlling the image signal outputted from the micro controlling unit 22. Also, the micro controlling unit 22 outputs image information to the display unit 24 according to the image signal. The display unit 24 is coupled to the controlling device 23 for displaying an image according the image information outputted by the controlling device 23.

Similarly, the FPGA 25 is coupled to the controlling device 23 for receiving the image information of the controlling device 23. The FPGA 25 comprises an operational logic circuit for processing and buffering the image information received from the controlling device 23, and then outputting the processed image information to the computer simulating terminal 26.

The computer simulating terminal 26 is coupled between the FPGA 25 and the micro controlling unit 22 for receiving the image information processed by the FPGA 25, simulating a display and comparing the display with the image provided from the field emission display driving circuit 2 to the display unit 24 under normal operation. According to the compared result, a compared signal is provided as a feedback to the micro controlling unit 22. Further, the micro controlling unit 22 adjusts the image signal according the compared signal outputted by the computer simulating terminal 26 for calibrating unexpected operations of the micro controlling unit 22 or the controlling device 23 so as to insure normal display.

Moreover, the field emission display driving circuit 2 further comprises a scratch pad memory, such as an SRAM 251, coupled to the FPGA 25 for providing a buffer memory for the operation of the FPGA 25. Because image information or data simultaneously outputted by the controlling device 23 is huge, the FPGA 25 is unable to process and output the image information to the computer simulating terminal 26 immediately. Thus, signals not being processed real time may be temporarily stored in the SRAM 251. Meanwhile, a method of buffering the image information into the SRAM 251 is needed before it is actually read from the SRAM 251 for processing.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A field emission display driving circuit for controlling a field emission display and monitoring the operation of the field emission display driving circuit, comprising:
an image signal generator for generating an image signal;
a micro controlling unit coupled to the image signal generator for receiving the image signal and controlling for output;
a controlling device coupled the micro controlling unit for receiving the image signal and controlling for outputting image information;
a display unit coupled to the controlling device for receiving the image information and displaying an image according to the image information;
a field programmable logic gate array coupled to the controlling device for receiving and performing an operation on the image information for output; and
a computer simulating terminal coupled to the field programmable logic gate array and the micro controlling unit for receiving the processed image information, simulating a display according the image information, and outputting the simulation result to the micro controlling unit for feedback calibration.

2. The field emission display driving circuit according to claim 1, wherein the field programmable logic gate array comprises an operational logic circuit for processing the operation of the image information.

3. The field emission display driving circuit according to claim 1, wherein the computer simulating terminal simulates the display of the image information, generates a compared signal by comparing the display with the image on the display unit under normal operation, and provides the compared signal as a feedback to the micro controlling unit for adjusting the image signal.

4. The field emission display driving circuit according to claim 1, wherein the field emission display driving circuit further comprises a scratch pad memory coupled to the field programmable logic gate array for buffering the image information.
